(19) United States
(12) Patent Application Publication
(10) Pub. No.: US 2007/0023225 A1
(43) Pub. Date: Feb. 1, 2007

(54) Saddle-type vehicle

(75) Inventors: Katsuhisa Abe, Shizuoka (JP); Takushirou Shiraishi, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA

(21) Appl. No.: 11/484,876

(22) Filed: Jul. 10, 2006

(30) Foreign Application Priority Data
Jul. 12, 2005 (JP) 2005-203264

(51) Int. Cl. B60K 13/04

(52) U.S. Cl. 180/309; 180/296

(57) ABSTRACT

A saddle-type vehicle in which contact with a hot exhaust pipe is prevented and transfer of the heat of the exhaust pipe is effectively interrupted. The exhaust pipe is disposed on the side of the engine, for guiding exhaust gas emitted from the engine. An exhaust pipe cover interrupts heat generated from the exhaust pipe. The exhaust pipe cover is disposed apart from the exhaust pipe and covers at least part of the exhaust pipe. The exhaust pipe cover has supported portions supported by a crankcase.

### BACKGROUND OF THE INVENTION

1. Field of the Invention

The present invention relates to a saddle-type vehicle having an internal combustion engine, and more particularly to an exhaust pipe disposed on the side of the internal combustion engine and an exhaust pipe cover that interrupts heat generated from the exhaust pipe.

2. Description of Related Art

Saddle-type vehicles such as motorcycles, which have an exhaust pipe on the side of a cylinder block of an internal combustion engine (engine), generally have a bolt mounting portion and a boss at the exhaust pipe to mount an exhaust pipe cover covering the exhaust pipe to thereby prevent riders from coming into contact with the exhaust pipe. See, for example, JP-A-9-32547 (pp. 2-3, FIG. 1).

In recent years, emission controls have gotten tougher and it is now absolutely necessary for saddle-type vehicles such as motorcycles to have a catalyst and a subcatalyst for purifying exhaust gas.

However, exhaust pipes having a catalyst tend to increase in temperature. Accordingly, conventional exhaust-pipe covers have the problem of increasing in temperature excessively.

### SUMMARY OF THE INVENTION

The present invention is made in view of this circumstance. Accordingly, it is an object of the present invention to provide a saddle-type vehicle in which contact with the hot exhaust pipe is prevented and transfer of the heat of the exhaust pipe is effectively interrupted.

In order to achieve this object, the invention has the following features. A first feature of the invention is a saddle-type vehicle including an internal combustion engine that generates a driving force for driving a wheel;an exhaust pipe disposed on the side of the internal combustion engine, for guiding exhaust gas emitted from the internal combustion engine; and an exhaust pipe cover that interrupts heat generated from the exhaust pipe. The exhaust pipe cover is disposed apart from the exhaust pipe and covers at least part of the exhaust pipe, and has supported portions supported by the internal combustion engine.

With this feature, the exhaust pipe cover is disposed apart from the exhaust pipe and covers at least part of the exhaust pipe, and is supported by the internal combustion engine. In other words, an air space is formed between the exhaust pipe and the exhaust cover. The temperature of the internal combustion engine that supports the exhaust pipe cover is lower than that of the exhaust pipe.

This arrangement effectively interrupts transfer of the heat of the exhaust pipe, preventing an increase in the temperature of the exhaust pipe cover itself by the heat of the exhaust pipe.

A second feature of the invention is an air space capable of ventilation in the vehicle front-back direction formed between the exhaust pipe and the exhaust pipe cover.

A third feature of the invention is that the internal combustion engine has a crankcase that houses a crankshaft and supports the supported portions.

A fourth feature of the invention is an exhaust pipe cover with an external portion disposed outside the exhaust pipe in the vehicle width direction. The external portion has a substantially flat shape in the vehicle front-back direction.

A fifth feature of the invention is that the vehicle further includes a fuel tank disposed above the internal combustion engine, for storing fuel to be supplied to the internal combustion engine; and steps projecting outward in the vehicle width direction relative to the internal combustion engine and below the internal combustion engine. The exhaust pipe cover is disposed inside the line connecting an external end of the fuel tank and an external end of the step in the vehicle width direction.

A sixth feature of the invention is that the vehicle further includes a body frame, wherein the exhaust pipe cover has an external portion disposed outside the exhaust pipe in the vehicle width direction and overlapping with an external end of the body frame in the vehicle width direction in cross section in the vehicle width direction.

A seventh feature of the invention is an exhaust pipe that has a catalyst for purifying the exhaust gas. The exhaust pipe cover covers the catalyst.

An eighth feature of the invention is that the vehicle further includes a body frame, wherein the exhaust pipe cover has a catalyst for purifying the exhaust gas. The catalyst is disposed between the crankcase and the body frame; and the supported portion is supported by the crankcase, under the catalyst.

A ninth feature of the invention is that the vehicle further includes steps projecting outward in the vehicle width direction relative to the internal combustion engine. The exhaust pipe cover is disposed above the steps, as viewed from the side of the vehicle, and at substantially the same position as the steps in the vehicle front-back direction.

A tenth feature of the invention is an exhaust pipe cover made of heat-resistant resin (e.g., polyamide resin).

An eleventh feature of the invention is that the heat-resistant resin is thermoplastic resin.

A twelfth feature of the invention is that the vehicle further includes a body frame that supports the exhaust pipe cover.

A thirteenth feature of the invention is that the exhaust pipe cover is supported by the body frame on the side of the catalyst.

With these features of the invention, a saddle-type vehicle is provided in which contact with a hot exhaust pipe is prevented and transfer of the heat of the exhaust pipe is effectively interrupted. Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a left side view of a motorcycle according to an embodiment of the invention.

FIG. 2 is a right side view of the motorcycle of the embodiment.

FIG. 3 is a fragmentary enlarged view of the right side of the motorcycle including an exhaust pipe cover according to the embodiment of the invention.

FIG. 4 is a cross-sectional view taken along line F4-F4 in FIG. 2.

FIG. 5 is a fragmentary enlarged view of the right side of the motorcycle including an exhaust cover according to a modification of the invention.

FIG. 6 is a cross-sectional view taken along line F6-F6 in FIG. 5.

### DETAILED DESCRIPTION OF THE INVENTION

Embodiments of the present invention are described in detail below with reference to the attached drawings. In the drawings, corresponding parts having corresponding functions have the same numerical designations. It is to be noted that the drawings are schematic and the ratios of the sizes illustrated in the drawings are different from those of real ones.

Accordingly, specific sizes should be determined in consideration of the following description. It is also to be understood that the drawings include different relationships and ratios among sizes.

(1) Overall Structure

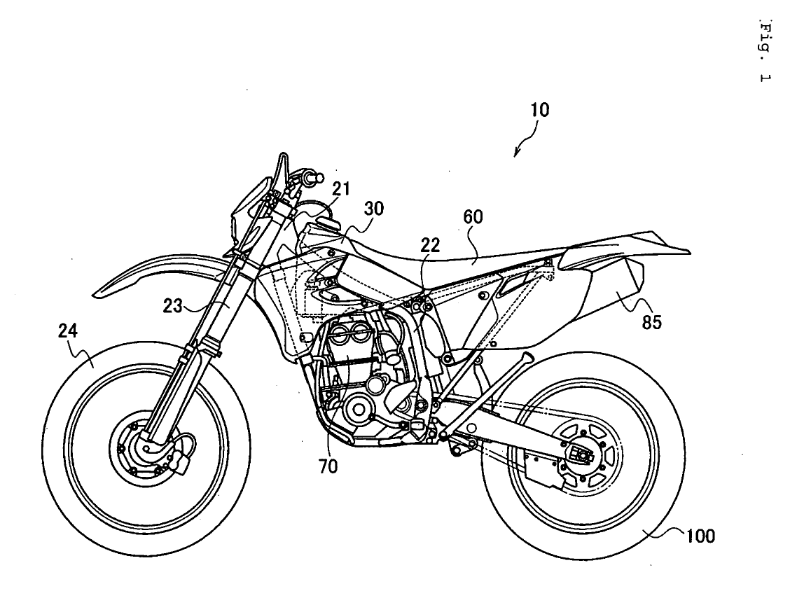

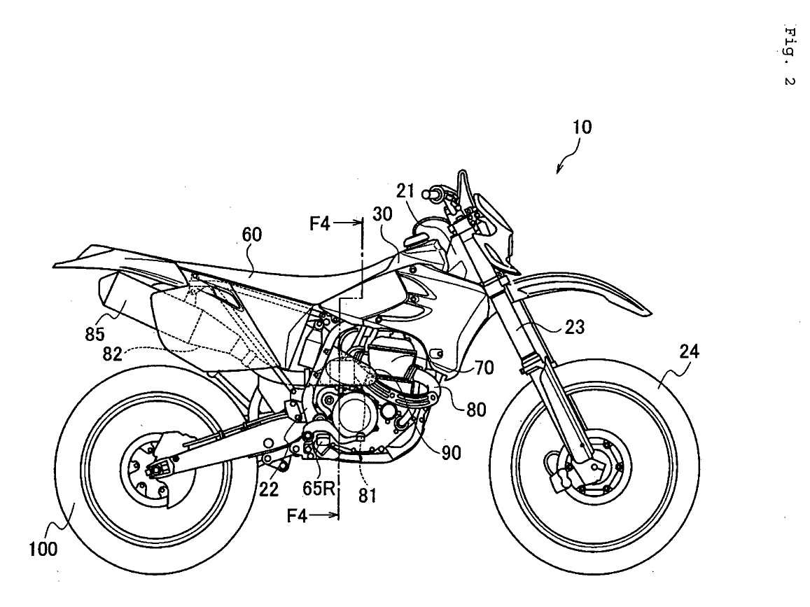

FIG. 1 is a left side view of a motorcycle 10, which is a saddle-type vehicle, according to an embodiment of the invention; and FIG. 2 is a right side view of the motorcycle 10.

As shown in FIGS. 1 and 2, the motorcycle 10 is an off-road motorcycle. The motorcycle 10 has a front fork 23 rotatably supported by a head pipe 21.

The front fork 23 rotatably supports a front wheel 24, and moves (translates) the front wheel 24 vertically (in actuality, in the direction given a specified caster angle) to thereby absorb an impact to the front wheel 24.

A frame pipe 22 (body frame) that forms the frame of the motorcycle 10 extends from the head pipe 21.

A fuel tank 30 is disposed above an engine 70 (internal combustion engine) that generates a driving force for driving a rear wheel 100 (wheel), and stores fuel (gasoline) to be supplied to the engine 70.

The motorcycle 10 has a seat 60 for a rider to sit on. The seat 60 has a form connecting to the fuel tank 30, part of the seat 60 overlapping with the fuel tank 30.

As shown in FIG. 2, an exhaust pipe 80 connected to the engine 70 is disposed on the right side of the motorcycle 10. The exhaust pipe 80 guides exhaust gas exhausted from the engine 70 to a muffler 85.

The exhaust pipe 80 has a subcatalyst 81 for purifying the exhaust gas from the engine 70 and a catalyst 82 located closer to the muffler 85 than the subcatalyst 81.

An exhaust pipe cover 90 interrupts heat generated by the exhaust pipe 80. The exhaust pipe cover 90 is disposed so as to cover the subcatalyst 81.

Steps 65R are portions for placement of the feet of the rider of the motorcycle 10. That is, the exhaust pipe cover 90 is disposed at a position corresponding to the leg of the rider of the motorcycle 10 when the rider is seated in the seat 60 and places his/her feet on the steps 65R.

(2) Detailed Structure Around Exhaust Pipe Cover

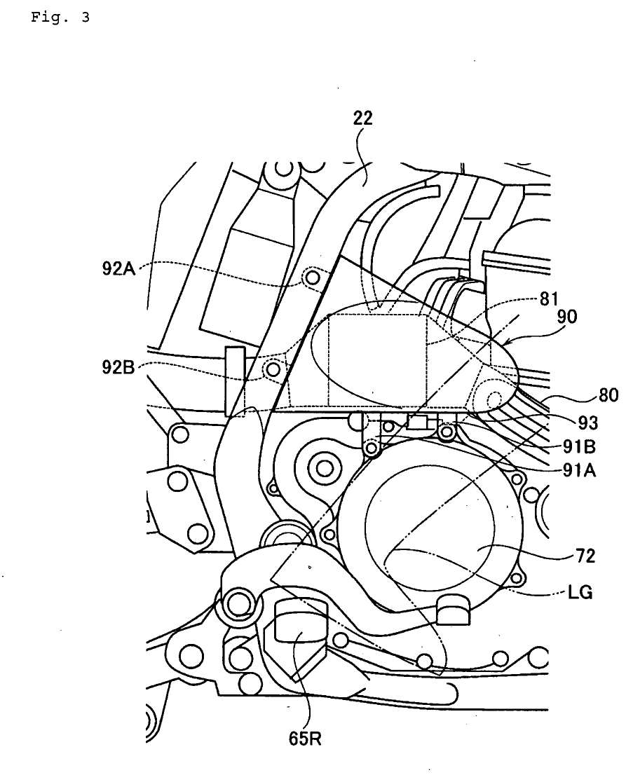

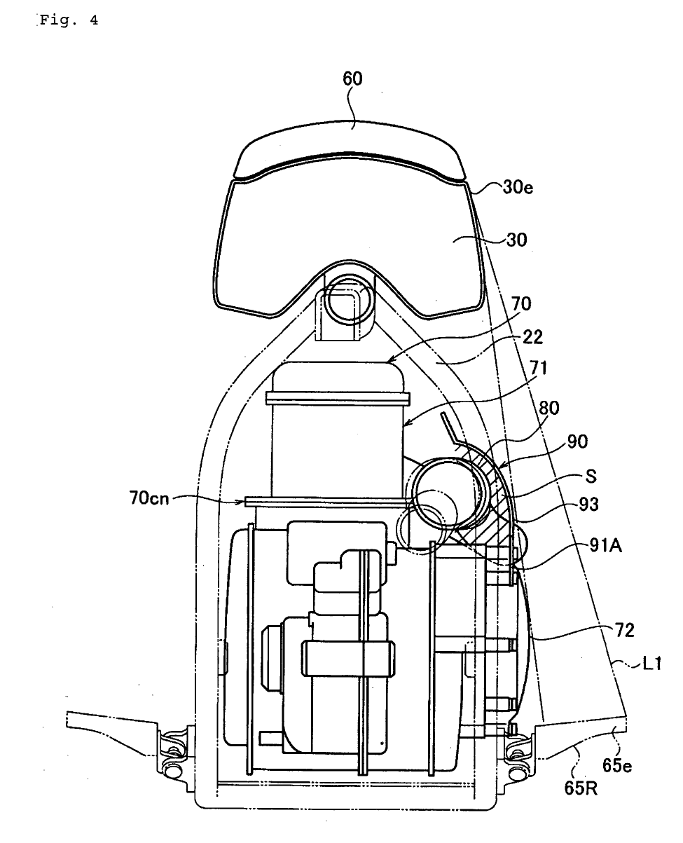

Referring next to FIGS. 3 and 4, the detailed structure around the exhaust pipe cover 90 which is an essential part of the invention will be described.

FIG. 3 is a fragmentary enlarged view of the right side of the motorcycle 10 including the exhaust pipe cover 90; and FIG. 4 is a cross-sectional view taken along line F4-F4 in FIG. 2.

As shown in FIGS. 3 and 4, the engine 70 includes a cylinder block 71 that reciprocates a piston (not shown) and a crankcase 72 for accommodating a crankshaft (not shown) that converts the reciprocating motion of the piston to a rotating motion.

The exhaust pipe cover 90 has supported portions 91A and 91B supported by the engine 70. Specifically, the supported portions 91A and 91B are supported by the crankcase 72.

As shown in FIG. 3, the exhaust pipe cover 90 is supported by the frame pipe 22 on the side of the subcatalyst 81.

In this embodiment, the exhaust pipe cover 90 has frame mounting portions 92A and 92B. The frame mounting portions 92A and 92B are secured to the frame pipe 22. That is, the exhaust pipe cover 90 is supported also by the frame pipe 22.

As shown in FIG. 4, the exhaust pipe cover 90 is disposed apart from the exhaust pipe 80. In other words, the exhaust pipe cover 90 has no contact with the exhaust pipe 80. As shown in FIG. 3, the exhaust pipe cover 90 covers at least part of the exhaust pipe 80.

An air space S is formed between the exhaust pipe 80 and the exhaust pipe cover 90 for ventilation in the front-back direction of the vehicle.

The steps 65R project outward relative to the engine 70 along the width of the vehicle, below the engine 70, or, in one embodiment, below the center 70cn of the engine 70. The center 70cn refers to the boundary between the cylinder block 71 and the crankcase 72.

The exhaust pipe cover 90 is disposed inside the line L1 connecting an external end 30e of the fuel tank 30 and an external end 65e of the step 65R along the width of the vehicle. The exhaust pipe cover 90 is disposed above the steps 65R, as viewed from the side of the motorcycle 10. The exhaust pipe cover 90 is disposed at substantially the same position as the steps 65R in the longitudinal direction of the vehicle.

The exhaust pipe cover 90 has an external portion 93 disposed outside the exhaust pipe 80 along the width of the vehicle. The external portion 93 has a substantially flat shape in the front-back direction of the vehicle.

As shown in FIG. 4, the subcatalyst 81 is disposed between the crankcase 72 and the frame pipe 22. The supported portion 91A (91B) is supported by the crankcase 72, under the subcatalyst 81.

The exhaust pipe cover 90 is formed of heat-resistant resin, or, in one embodiment, polyamide resin (nylon). The exhaust pipe cover 90 may be made of not only the polyamide resin but also other heat-resistant resins, such as thermoplastic resin.

(Operation and Advantages)

In the motorcycle 10 according to the embodiment, the exhaust pipe cover 90 is disposed apart from the exhaust pipe 80 and covers at least part of the exhaust pipe 80. The exhaust pipe cover 90 is supported by the engine 70, specifically, by the crankcase 72. In other words, an air space S is formed between the exhaust pipe 80 and the exhaust pipe cover 90. The temperature of the engine 70 that supports the exhaust pipe cover 90 is lower than that of the exhaust pipe 80.

Accordingly, transfer of the heat of the exhaust pipe 80 is interrupted effectively, thereby preventing the exhaust pipe cover 90 itself from becoming hot by the heat of the exhaust pipe 80.

Air space S between the exhaust pipe 80 and the exhaust pipe cover 90 is capable of ventilation in the vehicle front-back direction. Accordingly, when the motorcycle 10 runs, cool outside air enters the air space S heated by the exhaust pipe 80, thereby effectively preventing the exhaust pipe cover 90 itself from becoming hot.

The external portion 93 of the exhaust pipe cover 90 has a substantially flat shape in the front-back direction of the motorcycle 10. The exhaust pipe cover 90 is disposed inside the line L1 connecting the end 30e of the fuel tank 30 and the end 65e of the step 65R. Thus, the arrangement of the exhaust pipe cover 90 can decrease the times that the rider's legs come into contact with the exhaust pipe cover 90, without interference with the motion of the rider's legs.

The exhaust pipe cover 90 is disposed above the steps 65R, as viewed from the side of the motorcycle 10, and at substantially the same position as the steps 65R in the vehicle front-back direction. This can effectively prevent the rider's legs LG from coming into contact with the exhaust pipe 80 (the subcatalyst 81), as shown in FIG. 3.

The exhaust pipe cover 90 is disposed so as to cover the subcatalyst 81. This effectively interrupts the transfer of the heat of the subcatalyst 81 that becomes hot from the exhaust pipe 80.

The exhaust pipe cover 90 is supported also by the frame pipe 22. This arrangement effectively cools the exhaust pipe cover 90 heated by the exhaust pipe 80.

The exhaust pipe cover 90 is formed of heat-resistant resin (thermoplastic resin) such as polyamide resin. This arrangement effectively interrupts the transfer of the heat of the exhaust pipe 80 while reducing the weight of the exhaust pipe cover 90.

### Other Embodiments

While one embodiment of the invention has been, it is to be understood that the description and drawings of the disclosure do not limit the invention. It will be understood by those skilled in the art that various modifications may be made therein.

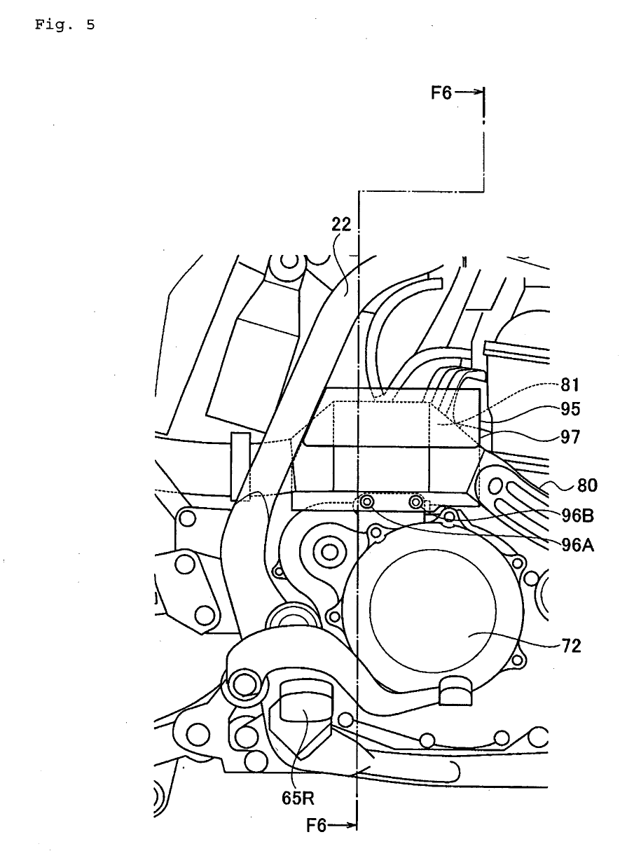

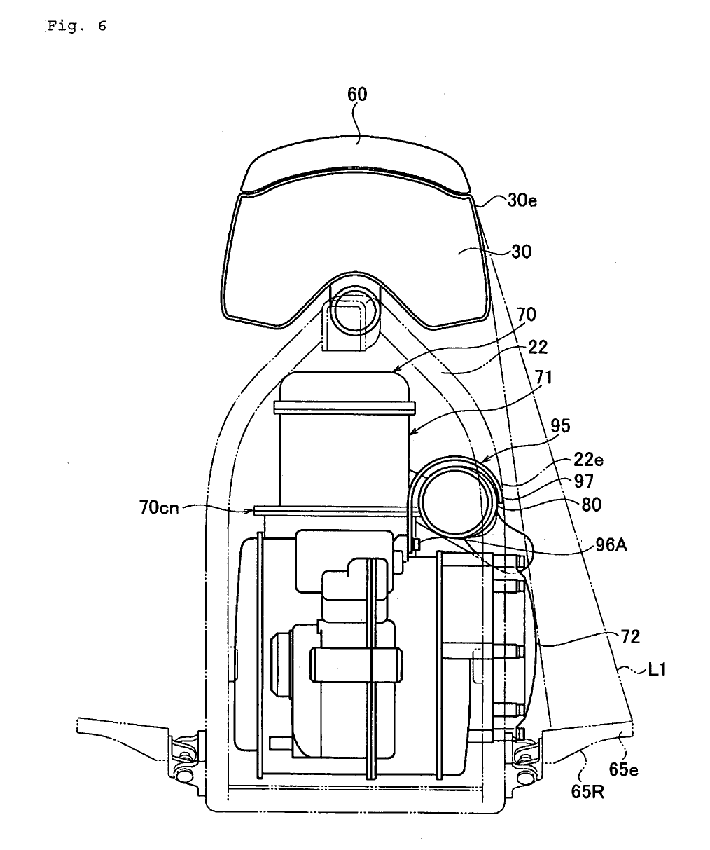

For example, the exhaust pipe cover 90 can be modified as shown in FIGS. 5 and 6:

FIG. 5 is a fragmentary enlarged view of the right side of the motorcycle 10 including an exhaust pipe cover 95 according to a modification of the invention; and FIG. 6 is a cross-sectional view taken along line F6-F6 in FIG. 5. Components different from the exhaust pipe cover 90 according to the embodiment of FIGS. 1-4 will be mainly described, while description of components that are the same as those previously described will be omitted.

The exhaust pipe cover 95 has an external portion 97 disposed outside the exhaust pipe 80 along the width of the vehicle.

As shown in FIG. 6, the external portion 97 is disposed to overlap with an end 22e of the frame pipe 22 in cross section in the vehicle width direction. In other words, the external portion 97 and the end 22e of the frame pipe 22 are substantially flush with each other.

The exhaust pipe cover 95 has supported portions 96A and 96B supported by the engine 70, or specifically, by the crankcase 72.

The supported portions 96A and 96B are disposed inside the exhaust pipe 80 in the vehicle width direction relative to the exhaust pipe 80. The exhaust pipe cover 95 extends to the external portion 97 disposed outside the exhaust pipe 80 in the vehicle width relative to the exhaust pipe 80 so as to surround the supported portions 96A and 96B across the periphery of the exhaust pipe 80.

Although, the exhaust pipe cover 90 has been described as having the frame mounting portions 92A and 92B, the frame mounting portions 92A and 92B may not necessarily be provided.

While the exhaust pipe cover 90 has been described as formed of heat-resistant resin (thermoplastic resin) such as polyamide resin, the exhaust pipe cover 90 may be formed of a material other than the heat-resistant resin.

While the motorcycle 10 has been described as including the subcatalyst 81 and the catalyst 82, the subcatalyst 81 and the catalyst 82 may not be provided.

While the exhaust pipe cover 90 has been described as disposed inside the line L1 connecting the end 30e of the fuel tank 30 and the end 65e of the step 65R, and at a position corresponding to the rider's leg, the exhaust pipe cover 90 may not necessarily be disposed at this position.

While the external portion 93 of the exhaust pipe cover 90 has been described as having a substantially flat shape in the front-back direction of the motorcycle 10, the external portion 93 of the exhaust pipe cover 90 may not necessarily be in a substantially flat shape.

While the exhaust pipe 80 has been described as disposed on the right side of the motorcycle 10, it may be disposed on the left side of the motorcycle 10.

While motorcycle 10 has been described as an off-road motorcycle, the invention can be applied to motorcycles other than the off-road motorcycles and other saddle-type motorcycles in which the exhaust pipe is disposed on the side of the engine (vehicle).

The particular embodiments of the invention described in this document should be considered illustrative, rather than restrictive. Modification to the described embodiments may be made without departing from the spirit of the invention as defined by the following claims.

1. A saddle-type vehicle comprising an internal combustion engine that generates a driving force for driving a wheel; an exhaust pipe disposed on a side of the internal combustion engine, for guiding exhaust gas emitted from the internal combustion engine; and an exhaust pipe cover that interrupts heat generated from the exhaust pipe, wherein
the exhaust pipe cover is disposed apart from the exhaust pipe and covers at least a part of the exhaust pipe; and
the exhaust pipe cover has a supported portion supported by the internal combustion engine.

2. The saddle-type vehicle according to claim 1, wherein an air space that ventilates in a vehicle front-back direction is formed between the exhaust pipe and the exhaust pipe cover.

3. The saddle-type vehicle according to claim 1, wherein
the internal combustion engine has a crankcase that houses a crankshaft; and
the supported portion is supported by the crankcase.

4. The saddle-type vehicle according to claim 1, wherein
the exhaust pipe cover has an external portion disposed outside the exhaust pipe in a vehicle width direction, and
the external portion has a substantially flat shape in a vehicle front-back direction.

5. The saddle-type vehicle according to claim 1, further comprising:
a fuel tank disposed above the internal combustion engine, for storing fuel to be supplied to the internal combustion engine; and
steps projecting outward in a vehicle width direction relative to the internal combustion engine and below the internal combustion engine, wherein
the exhaust pipe cover is disposed inside a line connecting an external end of the fuel tank and an external end of a step in the vehicle width direction.

6. The saddle-type vehicle according to claim 1, further comprising:
a body frame, wherein
the exhaust pipe cover has an external portion disposed outside the exhaust pipe in a vehicle width direction; and
the external portion is disposed to overlap with an external end of the body frame in the vehicle width direction in cross section in the vehicle width direction.

7. The saddle-type vehicle according to claim 1, wherein
the exhaust pipe has a catalyst for purifying the exhaust gas; and
the exhaust pipe cover covers the catalyst.

8. The saddle-type vehicle according to claim 2, further comprising a body frame, wherein
the exhaust pipe has a catalyst for purifying the exhaust gas;
the catalyst is disposed between a crankcase and the body frame; and
the supported portion is supported by the crankcase, under the catalyst.

9. The saddle-type vehicle according to claim 1, further comprising steps projecting outward in a vehicle width direction relative to the internal combustion engine, wherein
the exhaust pipe cover is disposed above the steps, as viewed from a side of the saddle-type vehicle, and at substantially a same position as the steps in a vehicle front-back direction.

10. The saddle-type vehicle according to claim 1, wherein the exhaust pipe cover is made of heat-resistant resin.

11. The saddle-type vehicle according to claim 10, wherein the heat-resistant resin is thermoplastic resin.

12. The saddle-type vehicle according to claim 1, further comprising:
a body frame, wherein
the exhaust pipe cover is supported by the body frame.

13. The saddle-type vehicle according to claim 12, wherein the exhaust pipe cover is supported by the body frame on a side of the catalyst.
